(19) United States
(12) Patent Application Publication
(10) Pub. No.: US 2010/0218064 A1
(43) Pub. Date: Aug. 26, 2010

(54) SEMICONDUCTOR MEMORY DEVICE INCORPORATING CONTROLLER

(76) Inventor: Takafumi ITO, Ome-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/710,723

(22) Filed: Feb. 23, 2010

(30) Foreign Application Priority Data
Feb. 24, 2009 (JP) 2009-041104

(51) Int. Cl. G06F 12/00; G06F 11/07

(52) U.S. Cl. 714/746; 711/154; 711/E12.001; 714/E11.023

(57) ABSTRACT

A semiconductor memory device includes a first nonvolatile memory, a second nonvolatile memory, a controller and an input/output bus. The first nonvolatile memory includes a plurality of memory cells having a first memory cell configuration. The second nonvolatile memory includes a plurality of memory cells having a second memory cell configuration different from the first memory cell configuration. The controller includes a first controller which controls the first nonvolatile memory, and a second controller which controls the second nonvolatile memory. An input/output bus is connected to the controller and is configured to exchange signals between an external apparatus and the controller. In accordance with a signal input via the input/output bus, the controller performs at least one of an operation of accessing the first nonvolatile memory by the first controller, and an operation of accessing the second nonvolatile memory by the second controller.

### CROSS-REFERENCE TO RELATED APPLICATIONS

This application is based upon and claims the benefit of priority from prior Japanese Patent Application No. 2009-041104, filed Feb. 24, 2009, the entire contents of which are incorporated herein by reference.

### BACKGROUND OF THE INVENTION

1. Field of the Invention

The present invention relates to a semiconductor memory device, e.g., a controller-embedded memory device incorporating a controller.

2. Description of the Related Art

Recently, a memory device including a nonvolatile memory such as a NAND flash memory is widely used in portable electronic apparatuses (host apparatuses) such as a digital camera, cell phone, and personal computer.

NAND flash memories are different in memory cell configuration including the page size, number of pages in a block, and number of recordable bits per memory cell. Examples of the page size are 2, 4, and 8 KB, examples of the number of pages in a block are 16, 32, and 64, and examples of the number of recordable bits per memory cell are one (single-level cell [SLC]), two (quaternary multi-level cell [MLC]), and three (octernary multi-level cell [MLC]).

Generally, the write/read performance (e.g., the write/read speed) per bit of the NAND flash memory improves as the page size decreases, the number of pages in a block decreases, and the number of recording bits per memory cell decreases.

By contrast, it is possible to increase the memory capacity and reduce the cost per bit as the page size increases, the number of pages in a block increases, and the number of recording bits per memory cell increases. Accordingly, different kinds of NAND flash memories are used in accordance with the performance characteristics and memory capacities required for various applications.

On the other hand, a controller-embedded memory device that improves the convenience of a NAND flash memory by incorporating a NAND controller for controlling the NAND flash memory into the same IC package as that of the NAND memory is becoming popular (e.g., Jpn. Pat. Appln. KOKAI Publication No. 2007-226380). A typical example is an embedded multimedia card (embedded MMC [eMMC]) adopting the Multimedia Card (MMC) standard as an interface with a host apparatus.

Conventionally, eMMCs incorporating NAND flash memories having different memory cell configurations are fabricated as different packages. That is, one NAND flash memory and its controller are incorporated into one package, and another NAND flash memory and its controller are incorporated into another package.

Some applications need to use an eMMC incorporating a high-speed, small-memory-capacity, small-page-size memory including SLCs as memory cells, and an eMMC incorporating a low-speed, large-memory-capacity, large-page-size memory including MLCs as memory cells. An example is a system in which the SLC eMMC is used as a memory device for storing various fine control data, and the MLC eMMC is used as a cell phone for storing large-volume music files.

In the conventional system like this, two packages of the SLC eMMC and MLC eMMC must be mounted on a substrate, and this increases the packaging area and packaging cost.

It is also possible to use one NAND flash memory as one eMMC by dividing the memory into an SLC-mode area and MLC-mode area. In this memory, however, it is difficult to obtain completely independent NAND characteristics in the two modes. This makes it difficult to form a memory device completely meeting the NAND characteristics required of the two modes.

### BRIEF SUMMARY OF THE INVENTION

According to a first aspect of the present invention, there is provided a semiconductor memory device comprising: a first nonvolatile memory comprising a plurality of memory cells having a first memory cell configuration; a second nonvolatile memory comprising a plurality of memory cells having a second memory cell configuration different from the first memory cell configuration; a controller comprising a first controller which controls the first nonvolatile memory, and a second controller which controls the second nonvolatile memory; and an input/output bus connected to the controller and configured to exchange signals between an external apparatus and the controller. In accordance with a signal input via the input/output bus, the controller performs at least one of an operation of accessing the first nonvolatile memory by the first controller, and an operation of accessing the second nonvolatile memory by the second controller.

According to a second aspect of the present invention, there is provided a semiconductor memory device comprising: a first nonvolatile memory comprising a plurality of memory cells having a first memory cell configuration; a second nonvolatile memory comprising a plurality of memory cells having a second memory cell configuration different from the first memory cell configuration; a first controller which controls the first nonvolatile memory; a second controller which controls the second nonvolatile memory; and a common input/output bus connected to the first controller and the second controller, and configured to exchange signals between an external apparatus and the first controller, and between the external apparatus and the second controller. In accordance with a signal input via the input/output bus, the first controller accesses the first nonvolatile memory, and the second controller accesses the second nonvolatile memory.

### BRIEF DESCRIPTION OF THE SEVERAL VIEWS OF THE DRAWING

FIG. 1 is a block diagram showing the configuration of an embedded multimedia card of a first embodiment of the present invention;

FIG. 2 is a block diagram showing a controller of the embedded multimedia card of the first embodiment;

FIG. 3 is a view showing command processing in the embedded multimedia card of the first embodiment;

FIG. 4 is a view showing a memory cell configuration of a NAND flash memory in the embedded multimedia card of the first embodiment;

FIG. 5 is a block diagram showing another controller of the embedded multimedia card of the first embodiment;

FIG. 6 is a block diagram showing another configuration example of the embedded multimedia card of the first embodiment;

FIG. 7 is a view showing a package structure of the embedded multimedia card of the first embodiment;

FIG. 8 is a block diagram showing the configuration of an embedded multimedia card of a second embodiment of the present invention; and

FIG. 9 is a block diagram showing the configuration of an embedded multimedia card of a third embodiment of the present invention.

### DETAILED DESCRIPTION OF THE INVENTION

Embodiments of the present invention will be explained below with reference to the accompanying drawing. In these embodiments, an embedded multimedia card (embedded MMC [eMMC], to be referred to as an embedded card hereinafter) will be taken as an example of a semiconductor memory device. In the following explanation, the same reference numerals denote the same parts throughout the drawing.

### 1. First Embodiment

First, an embedded card of the first embodiment of the present invention will be explained below.

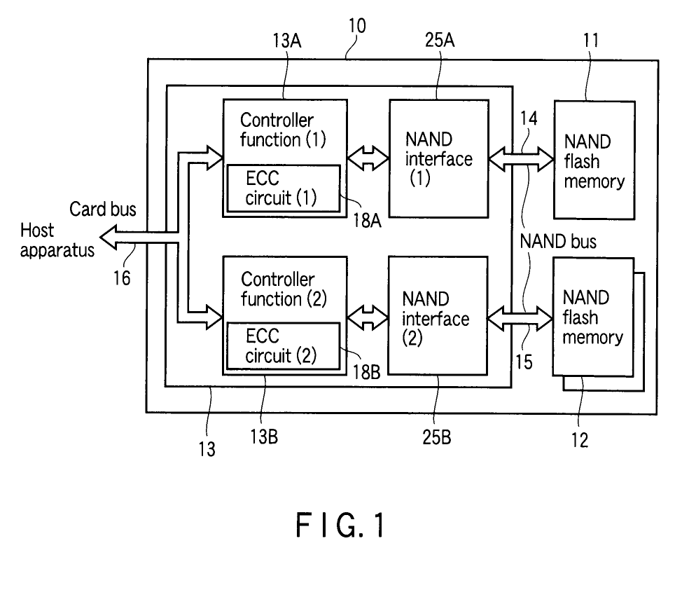

FIG. 1 is a block diagram showing the configuration of the embedded card of the first embodiment.

As shown in FIG. 1, an embedded card (device package) 10 includes NAND flash memories 11 and 12 and a controller 13.

NAND flash memories 11 and 12 are different in memory cell configuration or memory cell characteristic. That is, NAND flash memories 11 and 12 are different in page size, number of pages in a block, and number of recordable bits per memory cell, or write/read performance and memory cell reliability. The page is a write unit of a write operation. The block is an erase unit of an erase operation.

NAND flash memory 11 is, e.g., a small-capacity memory (e.g., 1 GB) in which memory cells are SLCs. NAND flash memory 12 is, e.g., a large-capacity memory (e.g., 16 GB) in which memory cells are MLCs.

The controller 13 controls the operations of NAND flash memories 11 and 12. The controller 13 incorporates two controllers, i.e., a control function (1) 13A and control function (2) 13B, a NAND interface (1) 25A, and NAND interface (2) 25B. The controller 13 can be fabricated by one semiconductor chip (controller chip), and can also be formed on a semiconductor chip on which another circuit is formed.

Control function (1) 13A controls NAND flash memory 11 via NAND interface (1) 25A and a NAND bus (or signal bus) 14. Control function (2) 13B controls NAND flash memory 12 via NAND interface (2) 25B and a NAND bus (or signal bus) 15.

Control function (1) 13A incorporates an error check and correction (ECC) circuit (1) 18A for correcting a data error in NAND flash memory 11. Control function (2) 13B incorporates an ECC circuit (2) 18B for correcting a data error in NAND flash memory 12.

Since the SLC NAND flash memory 11 and MLC NAND flash memory 12 are different in required error correction capability, ECC circuit (1) 18A and ECC circuit (2) 18B are also different in error correction capability. For example, ECC circuit (1) 18A has an error correction capability of 4 bits per 512 bytes, and ECC circuit (2) 18B has an error correction capability of 16 bits per 512 bytes.

The cost and characteristics of the controller can be optimized by thus incorporating the optimum ECC circuits corresponding to the characteristics of NAND flash memories 11 and 12 into the control functions 13A and 13B.

The embedded card 10 is inserted into a card insertion portion of a host apparatus as needed, and exchanges signals with the host apparatus via a card bus (or input/output bus or signal pin) 16. When exchanging signals, the embedded card 10 and host apparatus are connected by the card bus 16, and the host apparatus detects through the card bust 16 that the two NAND flash memories 11 and 12 exist. That is, the host apparatus detects the existence of the two memory devices through the common bus. Note that examples of the host apparatus are portable electronic apparatuses such as a digital camera, cell phone, and personal computer.

The controller 13 stores different data in NAND flash memories 11 and 12 by using their different characteristics. For example, the controller 13 uses NAND flash memory 11 to rapidly write random addresses with a small write size and save, e.g., host system control data requiring high reliability by using control function (1). Also, the controller 13 uses NAND flash memory 12 to save, e.g., multimedia contents requiring a large capacity and mainly written by sequential file write by using control function (2).

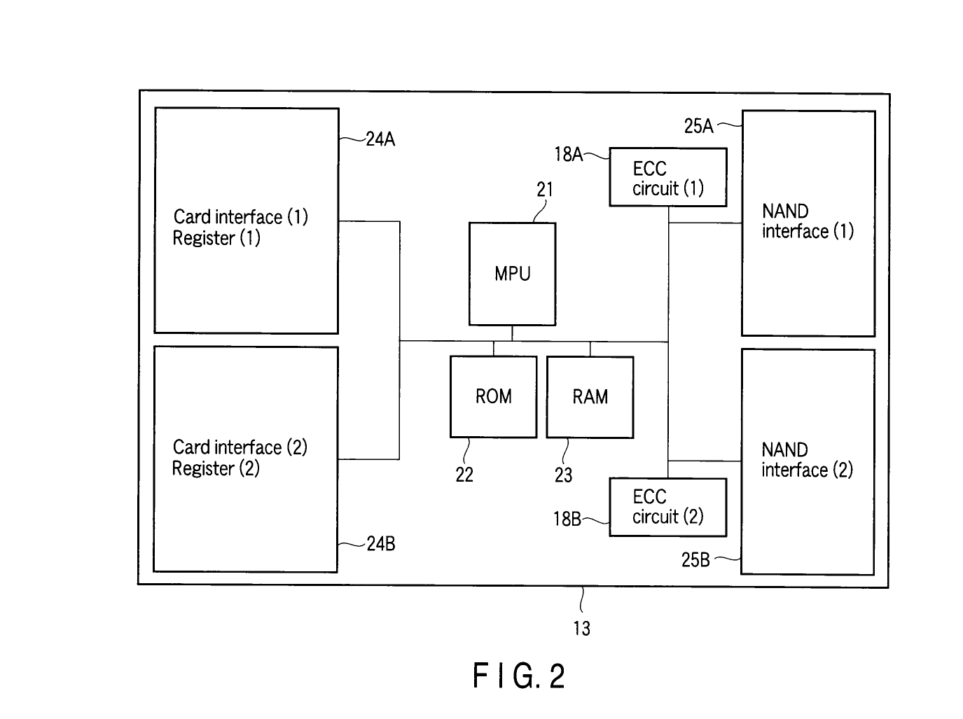

FIG. 2 is a block diagram showing the configuration of the controller 13. The controller 13 includes a processor (e.g., an MPU 21), ROM 22, RAM 23, ECC circuit (1) 18A, ECC circuit (2) 18B, card interface (1) 24A, card interface (2) 24B, NAND interface (1) 25A, and NAND interface (2) 25B.

Card interfaces 24A and 24B perform interface processing between the controller 13 and an external host apparatus. Card interface 24A is installed for control function (1), and includes register (1) for holding signals exchanged with the host apparatus. Card interface 24B is installed for control function (2), and includes register (2) for holding signals exchanged with the host apparatus.

The MPU 21 controls the operation of the embedded card 10. More specifically, the MPU 21 receives a write command, read command, and erase command from the host apparatus, and executes predetermined processing for NAND flash memories 11 and 12. The MPU 21 processes various commands input from the host apparatus, and processes two functions, i.e., control function (1) 13A and control function (2) 13B. This makes it possible to simplify the circuit configuration of the controller 13, and reduce the controller cost.

Unfortunately, the MPU 21 cannot simultaneously execute processing for NAND flash memory 11 and that for NAND flash memory 12. Therefore, while command processing for one NAND flash memory is being performed, command processing for the other NAND flash memory is waiting in the controller 13. This slightly decreases the overall throughput.

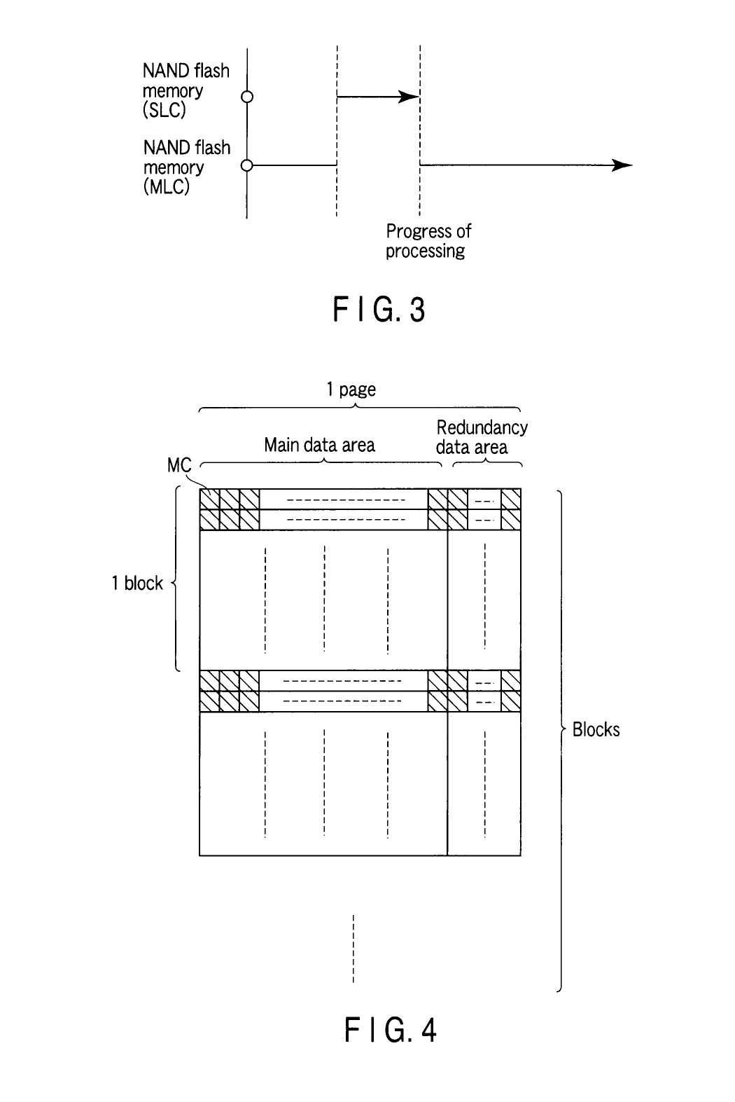

Commands for the SLC NAND flash memory 11 originally require high-speed processing. As shown in FIG. 3, therefore, when receiving a command for the SLC NAND flash memory 11 while processing a command for the MLC NAND flash memory 12, the MPU 21 interrupts the command processing for NAND flash memory 12 and preferentially processes the command for NAND flash memory 11.

The ROM 22 stores firmware (a control program) for the MPU, fixed data, and the like. The RAM 23 stores various conversion tables and variables, and is also used as a work area of the MPU 21. NAND interfaces 25A and 25B perform interface processing between the controller 13 and NAND flash memories 11 and 12.

In the embedded card 10 having the configuration as described above, two control functions (1) and (2) can perform control operations suited to the two NAND flash memories 11 and 12 different in page size, number of pages in a block, number of recordable bits per memory cell, write/read performance, and memory cell reliability.

The memory cell configuration of NAND flash memories 11 and 12, i.e., the page size, number of pages in a block, and number of recordable bits per memory cell will be explained below with reference to FIG. 4.

As shown in FIG. 4, NAND flash memories 11 and 12 each include a plurality of blocks in the form of a memory cell array. Each block includes a plurality of pages. Each page has a main data area and redundancy data area. In the main data area, a plurality of memory cells for storing data are arranged. In the redundancy data area, a plurality of spare memory cells to be used to replace defective memory cells by the ECC circuit are arranged.

Examples of the memory configuration of the SLC NAND flash memory 11 are that the storage capacity is 1 GB, the number of recordable bits per memory cell is 1, the page size is 2 KB, the number of pages in a block is 16, and the number of blocks is about 33,000. Examples of the memory configuration of the MLC NAND flash memory 12 are that the storage capacity is 8 GB, the number of recordable bits per memory cell is 2 or 3, the page size is 8 KB, the number of pages in a block is 64, and the number of blocks is about 16,400.

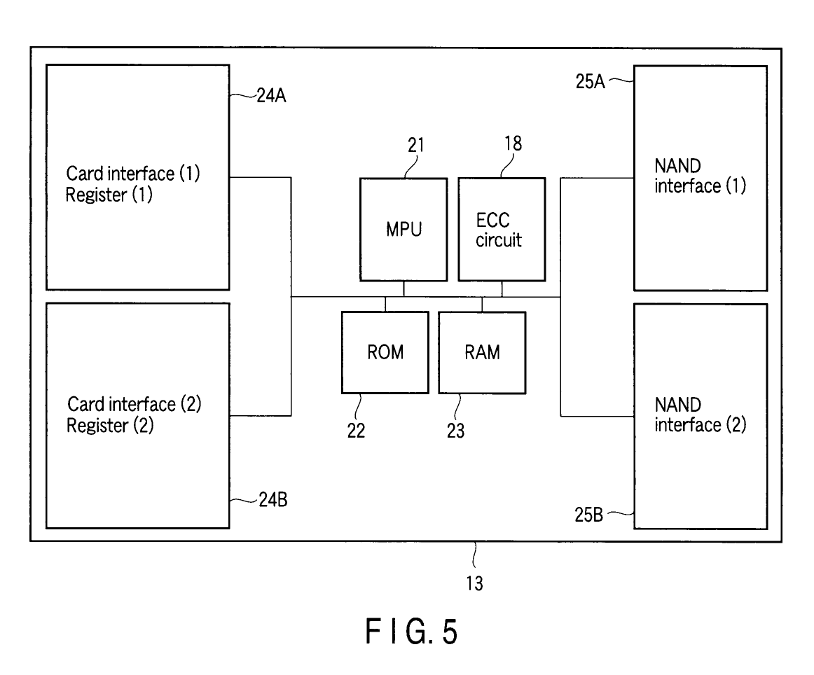

A configuration as shown in FIG. 5 may also be used in place of the configuration shown in FIG. 2. The configuration shown in FIG. 2 includes ECC circuit (1) 18A for NAND flash memory 11, and ECC circuit (2) 18B for NAND flash memory 12. The configuration shown in FIG. 5 includes one ECC circuit 18 for NAND flash memories 11 and 12.

If the same error correction capability is applicable to NAND flash memories 11 and 12, processing can be performed by one common ECC circuit. In this configuration, error correction cannot simultaneously be performed for NAND flash memories 11 and 12. However, it is possible to simplify the circuit configuration of the controller 13, and reduce the controller cost.

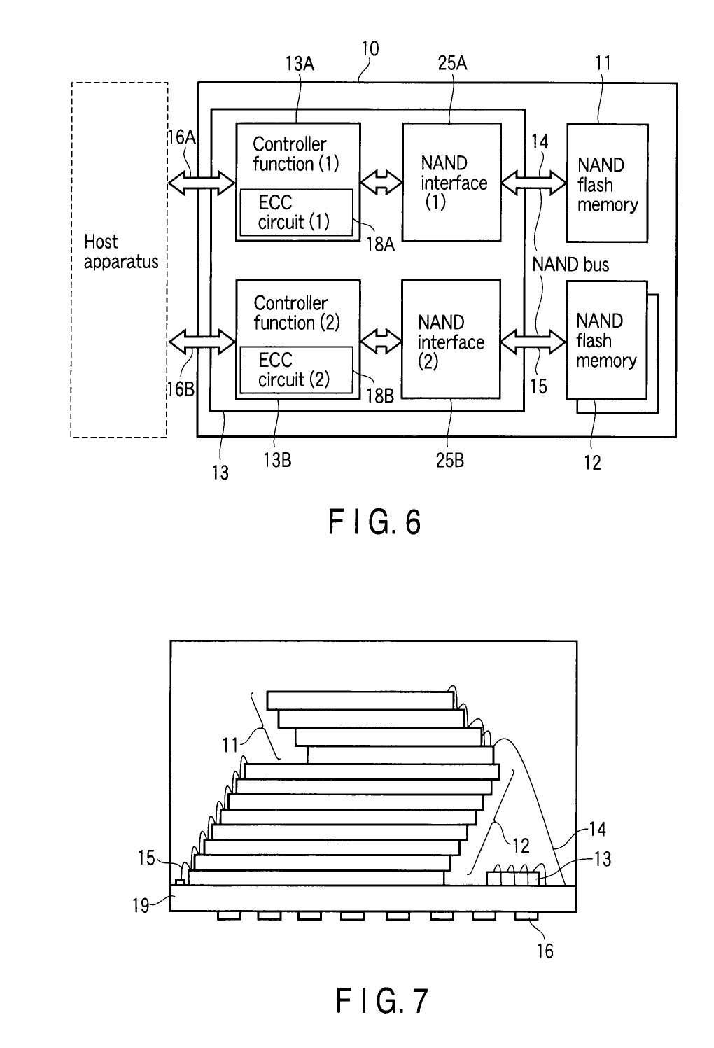

Furthermore, a configuration shown in FIG. 6 may also be used in place of the configuration shown in FIG. 1. In the configuration shown in FIG. 1, the host apparatus and control functions 13A and 13B are connected via the common card bus 16. In the configuration shown in FIG. 6, the host apparatus and control functions 13A and 13B are respectively connected by card buses 16A and 16B.

In this configuration, the number of pins of the controller 13 increases. However, control functions 13A and 13B can simultaneously exchange commands and data with the host apparatus. This makes it possible to improve the operating performance of the embedded card 10.

FIG. 7 shows the package structure of the embedded card 10 shown in FIG. 1. FIG. 7 shows the internal structure of the package viewed from its side surface.

As shown in FIG. 7, the MLC NAND flash memory 12 is mounted on the first major surface of a substrate 19. The SLC NAND flash memory 11 is mounted on NAND flash memory 12. On the first major surface of the substrate 19, the controller 13 is mounted adjacent to NAND flash memory 12.

A wire as NAND bus 14 is formed between the controller 13 and NAND flash memory 11. A wire as NAND bus 15 is formed between the controller 13 and NAND flash memory 12. In addition, terminals as the card bus 16 for connecting the controller 13 and a host apparatus are formed on the second major surface of the substrate 19.

In the first embodiment, it is possible to maximally utilize the NAND memory characteristics of a plurality of kinds of nonvolatile memories having different memory configurations, i.e., the small-capacity NAND flash memory 11 including SLCs as memory cells and the large-capacity NAND flash memory 12 including MLCs as memory cells. It is also possible to form an embedded card that can be downsized and fabricated at a low cost.

### 2. Second Embodiment

An embedded card of the second embodiment of the present invention will be explained below. In the first embodiment, the two NAND interfaces 25A and 25B are respectively arranged between the controller 13 and NAND flash memories 11 and 12. In the second embodiment, one NAND interface and a common NAND bus are installed.

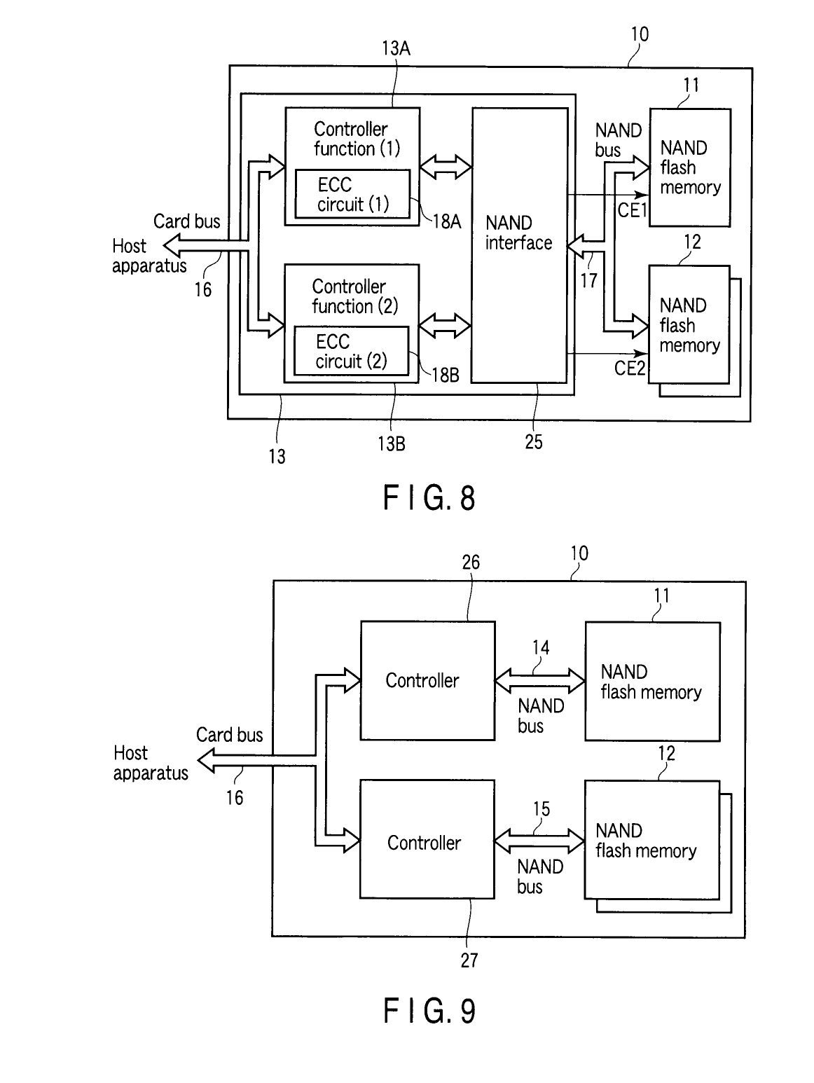

FIG. 8 is a block diagram showing the configuration of the embedded card of the second embodiment.

As shown in FIG. 8, a controller 13 includes a NAND interface 25 as an interface between control functions 13A and 13B and NAND flash memories 11 and 12. In addition, a NAND bus 17 for exchanging signals is installed between the NAND interface 25 and NAND flash memories 11 and 12.

Although NAND flash memories 11 and 12 share the NAND bus 17, chip enable signals CE1 and CE2 for NAND flash memories 11 and 12 are different. NAND flash memories 11 and 12 can be controlled by one NAND bus (except for the chip enable signals) by controlling chip enable signal CE1 for enabling NAND flash memory 11, and chip enable signal CE2 for enabling NAND flash memory 12.

The second embodiment having the above configuration can reduce the number of pins of the controller 13, thereby decreasing the chip size of the controller 13. The rest of the configuration and effects are the same as those of the first embodiment described previously.

### 3. Third Embodiment

An embedded card of the third embodiment of the present invention will be explained below. The third embodiment includes two controller chips having control functions (1) and (2) respectively.

FIG. 9 is a block diagram showing the configuration of the embedded card of the third embodiment.

As shown in FIG. 9, an embedded card 10 includes two controllers 26 and 27 and NAND flash memories 11 and 12. Controller 26 has control function (1), and controller 27 has control function (2). Controllers 26 and 27 are fabricated by different semiconductor chips (controller chips).

In the third embodiment, the cost is higher than that of the first embodiment because the two controller chips are necessary. However, the functions of controllers 26 and 27 are simple, and this facilitates the development, design, and fabrication. The rest of the configuration and effects are the same as those of the first embodiment.

Note that the first to third embodiments are examples in which the small-capacity NAND flash memory 11 including SLCs as memory cells and the large-capacity NAND flash memory 12 including MLCs as memory cells are used as memories of an embedded memory device. However, the present invention is also applicable even when memories 11 and 12 are replaced with the following combinations.

(1) A combination of a large-block-type NAND memory and small-block-type NAND memory.

(2) A combination of a NAND flash memory including MLCs as memory cells and having a large page length (e.g., 8 KB), and a NAND flash memory including MLCs as memory cells and having a small page length (e.g., 2 KB).

(3) A combination of a NAND flash memory including MLCs as memory cells and capable of recording 2 bits data per memory cell, and a NAND flash memory including MLCs as memory cells and capable of recording 4 bits data per memory cell.

(4) A combination of a nonvolatile memory (e.g., a ferroelectric memory [ReRAM]) other than a NAND flash memory, and a NAND flash memory.

Note also that each embodiment is an example of a controller-embedded multimedia card, but the present invention can also be applied to a device complying with another host interface standard, e.g., to a controller-embedded SD memory card (eSD).

As described above, each embodiment of the present invention can implement a small-sized, low-cost semiconductor memory device capable of maximally utilizing the characteristics of a plurality of kinds of nonvolatile memories having different memory cell configurations.

Note that the embodiments described above can singly be practiced and can also be practiced as they are appropriately combined. In addition, the above-mentioned embodiments incorporate inventions in various stages. Therefore, these inventions in various stages can be extracted by appropriately combining a plurality of constituent elements disclosed in the embodiments.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A semiconductor memory device comprising:
a first nonvolatile memory comprising a plurality of memory cells having a first memory cell configuration;
a second nonvolatile memory comprising a plurality of memory cells having a second memory cell configuration different from the first memory cell configuration;
a controller comprising a first controller which controls the first nonvolatile memory, and a second controller which controls the second nonvolatile memory; and
an input/output bus connected to the controller and configured to exchange signals between an external apparatus and the controller,
wherein in accordance with a signal input via the input/output bus, the controller performs at least one of an operation of accessing the first nonvolatile memory by the first controller, and an operation of accessing the second nonvolatile memory by the second controller.

2. The device according to claim 1, wherein a difference between the first memory cell configuration and the second memory cell configuration is at least a stored information amount per memory cell.

3. The device according to claim 1, wherein a difference between the first memory cell configuration and the second memory cell configuration is at least one of a page size, the number of pages in a block, and a stored information amount per memory cell, the page is a write unit of a write operation, and the block is an erase unit of an erase operation.

4. The device according to claim 1, wherein
the first controller comprises a first error correction circuit corresponding to the first nonvolatile memory, and
the second controller comprises a second error correction circuit corresponding to the second nonvolatile memory.

5. The device according to claim 4, wherein
the first error correction circuit corrects an error of data stored in the first nonvolatile memory, and
the second error correction circuit corrects an error of data stored in the second nonvolatile memory.

6. The device according to claim 1, wherein the controller comprises a first interface which receives a command for the first nonvolatile memory, a second interface which receives a command for the second nonvolatile memory, and a processor which processes the commands received by the first interface and the second interface.

7. The device according to claim 6, wherein the processor has priority on the processing of the commands for the first nonvolatile memory and the second nonvolatile memory, and controls a processing sequence of the commands received by the first interface and the second interface in accordance with the priority.

8. The device according to claim 1, wherein the controller comprises one semiconductor chip.

9. The device according to claim 1, wherein a common signal bus connects the first nonvolatile memory, the second nonvolatile memory, and the controller.

10. The device according to claim 1, wherein the input/output bus comprises a first card bus which exchanges signals between the first controller and an external apparatus, and a second card bus which exchanges signals between the second controller and the external apparatus.

11. A semiconductor memory device comprising:
a first nonvolatile memory comprising a plurality of memory cells having a first memory cell configuration;
a second nonvolatile memory comprising a plurality of memory cells having a second memory cell configuration different from the first memory cell configuration;
a first controller which controls the first nonvolatile memory;
a second controller which controls the second nonvolatile memory; and
a common input/output bus connected to the first controller and the second controller, and configured to exchange signals between an external apparatus and the first controller, and between the external apparatus and the second controller,
wherein in accordance with a signal input via the input/output bus, the first controller accesses the first nonvolatile memory, and the second controller accesses the second nonvolatile memory.

12. The device according to claim 11, wherein a difference between the first memory cell configuration and the second memory cell configuration is at least a stored information amount per memory cell.

13. The device according to claim 11, wherein a difference between the first memory cell configuration and the second memory cell configuration is at least one of a page size, the number of pages in a block, and a stored information amount per memory cell, the page is a write unit of a write operation, and the block is an erase unit of an erase operation.

14. The device according to claim 11, wherein the first controller comprises a first semiconductor chip, and the second controller comprises a second semiconductor chip different from the first semiconductor chip.
